(19) United States
(12) Patent Application Publication
(10) Pub. No.: US 2004/0157193 A1
(43) Pub. Date: Aug. 12, 2004

(54) Computer-aided design and production of an online learning course

(76) Inventors: Ulises Ali Mejias, Ithaca, NY (US); Charles David Corbin, Boulder, CO (US); James P. Frenette II, Ithaca, NY (US); Michael Joseph Grace-Martin, Ithaca, NY (US)

Correspondence Address: NIXON & VANDERHYE, PC, 1100 N GLEBE ROAD, 8TH FLOOR, ARLINGTON, VA, 22201-4714, US

(21) Appl. No.: 10/431,581

(22) Filed: May 8, 2003

Related U.S. Application Data
(60) Provisional application No. 60/445,831, filed on Feb. 10, 2003.

(51) Int. Cl. G09B 19/00

(52) U.S. Cl. 434/118

(57) ABSTRACT

A computer-aided method for deigning and producing an online course is described. An electronic online course structure is generated using one or more clusters of learning objects corresponding to learning molecules. Each learning molecule defines a course topic around which a learning experience is organized. An XML course structure document is generated from an electronic online course overview. During an initial phase of development, one or more directories of placeholder course web pages are automatically generated to mirror the course structure defined in the course structure document. Each placeholder course web page corresponds to one of the learning objects associated with each learning molecule. During a second phase of development, course content is produced for each learning object, and learning objects are embedded into the placeholder web pages. Web page properties are defined for each course web page. Navigational hyperlinks are created between the course web pages based on the hierarchy described in the course structure document. The web pages are compiled into a finished web-based online course and provided as a software product or sent to an online course deployment server.

This application claims priority from U.S. provisional application serial No. 60/445,831, filed on Feb. 10, 2003, the disclosure of which is incorporated here by reference.

### FIELD OF THE INVENTION

The present invention relates to online learning, and in particular, to designing and producing online learning systems.

### BACKGROUND AND SUMMARY

Computer-based and network-based educational and training programs are an important feature of the current and future educational landscape. The Internet and World Wide Web provide universal access, better communication, and interactive, media rich environments to support a wide variety of learning needs. Online learning presents advantages over traditional learning environments such as learner participation from remote locations, immediate access to a wealth of training and educational materials, and the opportunity to practice skills in a multimedia, risk-free environment. Web-based learning also allows students more flexibility in scheduling the time they devote to learning.

Translating rich educational content from a face-to-face environment to an online environment poses many interesting challenges. Whereas the process of creating classroom courses is usually the responsibility of a single person—the course instructor—designing and creating an online course is a complex team process. It involves the faculty or instructor in the role of a subject matter expert (SME), as well as learning designers, content writers, multi-media programmers, project managers, and many other people without whom it would be difficult to produce and deliver an online course. An online course development process typically also imposes organizational constraints such as strict production time-lines, limited resources, and scheduling conflicts. Because online learning is still a developing field, subject matter experts often lack a high level of experience in applying online learning principles, and must rely on the expertise of the online course developers.

The inventors recognized that successful online course development is facilitated when the members on the development team use a common language and structure to define a learning experience. This common language and structure helps all team members build connections between what subject matter experts believe is the most effective way to organize educational content and what online course developers believe is the best online learning strategy to deliver that content. And, as explained below, the common language and structure also supports the team's efforts to design and build an online course of particular dimensions with a given set of resources.

The “learning molecule” is the centerpiece of the common language used to design and produce online courses. A learning molecule is the basic unit of content around which an online learning system is organized. In a preferred example embodiment, each learning molecule includes a combination or cluster of learning objects from the following groups: scenario, resource, utility, collaboration, and evaluation. The scenario learning objects establish a situation that provides the context and/or motivation for learning. The resource learning objects include materials that provide theoretical knowledge needed to understand the scenario. The utility learning objects include tools that facilitate the application of knowledge and the practice of skills. The collaboration learning objects include tools that allow communities of learners to share, compare, and discuss knowledge. The evaluation learning objects include instruments that measure comprehension and progress.

Each learning object is implemented using an electronic tool from a learning object toolset. The toolset is a collection of pre-defined templates that allow content and graphic design to change while maintaining their basic functionality. Each item or template in this toolset is called a learning object tool.

In order to estimate the average time it takes a student to review a particular learning object and the effort it takes to produce such a learning object, two “cost” measures are used: learner weight (LW) and production weight (PW). The learner weight estimates the amount of time a learner will spend engaged in working with a particular object. The production weight measures the effort involved when producing a particular learning object tool, taking into account both subject matter expert effort and online course developer effort. The designers can thus obtain a quantitative estimate of the total length of the course and the production costs associated with its creation by adding up the learner and production weights of all learning objects in the learning system.

In accordance with an example embodiment, a system for designing an online course includes one or more online course design workstations that communicate with an online course development server. An overview document representing a course is assembled by defining a set of modules. Each module contains a sequence of learning molecules (analogous to topics), and each learning molecule is defined by a cluster of learning objects. An XML course structure document is derived from the electronic online course overview. An online course development server automatically generates one or more directories of placeholder course web pages to mirror the course structure defined in the course structure document. Each placeholder course web page corresponds to one of the learning objects associated with each learning molecule. A memory stores learning object tools used to construct one or more learning molecules, each learning molecule defining a course topic around which a learning experience is organized. Course content is produced for each learning object, and finished learning objects are embedded into the placeholder web pages. Web page properties are defined for each course web page. Navigational hyperlinks are created between the course web pages based on the hierarchy described in the course structure document. A course compiler associated with the online course development server compiles the web pages into a finished web-based, online course. The finished online course is provided to the deployment server where it can be accessed by learner client computers via the Internet.

The online course may also be provided as a software product. The software memory product includes online communication components for communicating with one or more client computers associated with the persons taking the web based online course and a presentation software module that stores the online course web page files. Each web page file includes a number of data structures used for generating various displays and possibly other media to facilitate the online learning experience of the learner.

### BRIEF DESCRIPTION OF THE DRAWINGS

The present invention may be more readily understood with reference to the following description taken in conjunction with the accompanying drawings.

FIG. 1 is a diagram illustrating a web-based, online course design and production system;

FIG. 2 is a diagram showing learners participating in a web-based, online course;

FIG. 3 is a diagram illustrating a learning molecule made up of learning object tools;

FIG. 4 illustrates a table of online learning object tools;

FIG. 5 is a flowchart diagram illustrating example procedures for an online course design;

FIG. 6 is an example of how a learning molecule is represented in the course overview document;

FIG. 7 is an example XML document corresponding to the example learning module shown in FIG. 6;

FIG. 8 is an example course directory structure used in the design of the example online course illustrated in FIG. 6;

FIG. 9 illustrates an example placeholder web page ready for course content;

FIG. 10 illustrates learning content for one of the web pages associated with the learning module of FIG. 6;

FIG. 11 is a display screen shot of a finalized web page associated with one of the learning objects associated with the learning molecule of FIG. 6;

FIG. 12 is a flowchart illustrating example procedures of a web page compiler routine;

FIG. 13 shows the example course directory structure after compiling; and

FIG. 14 is a simplified function block diagram of an online course product.

### DETAILED DESCRIPTION

In the following description, for purposes of explanation and not limitation, specific details are set forth such as particular embodiments, procedures, techniques, etc. in order to provide a thorough understanding of the present invention. However, it will be apparent to one skilled in the art that the present invention may be practiced in other embodiments that depart from these specific details. In some instances, detailed descriptions of well-known methods, interfaces, devices, and techniques are omitted so as not to obscure the description of the present invention with unnecessary detail. The present invention is described with reference to block diagram and flowchart illustrations according to a non-limiting example of the invention.

It will be understood that each block or a combination of blocks may be implemented by computer program instructions. These computer instructions may be loaded onto a general purpose computer, special purpose computer, or other programmable data processing apparatus to produce a machine such that the instructions which execute in the computer or other data processing apparatus implement the function(s) specified in the block or blocks. Each block may also be implemented by a special purpose, hardware-based system which performs specified functions or steps.

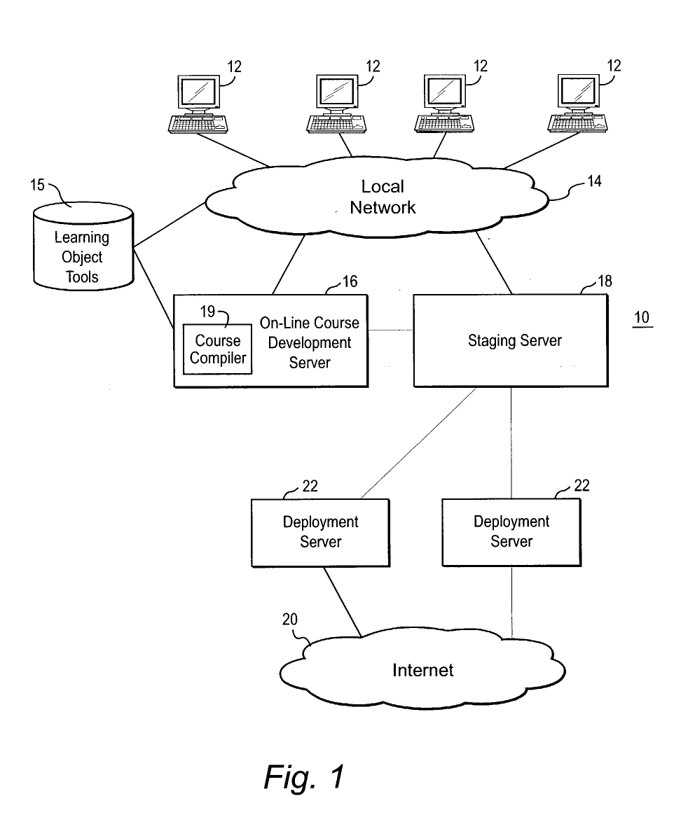

FIG. 1 illustrates a diagram of a computer-aided online course design and production system 10. Plural course design workstations are coupled to a local network 14 or to the Internet 20 for purposes of providing input of various types of information from different sources for the online course design. The local network 14 is an example mechanism for permitting communication between the course design workstations and the online course development server 16. Learning object tools are stored in a memory 15, such as one or more databases, and are accessible by the online course development server 16 and the local network 14. The online course development server 16 also includes a course compiler 19 for compiling final web pages onto the online course, which is uploaded to a staging server 18 also coupled to the local network 14 for purposes of assembly and testing. Once the course is completed, it is uploaded to one or more deployment servers 22. The course is then accessible to students via the Internet 20 using personal computers. Alternatively, the online course may be stored in a memory device and provided as a software product that may be run on a suitable computer server.

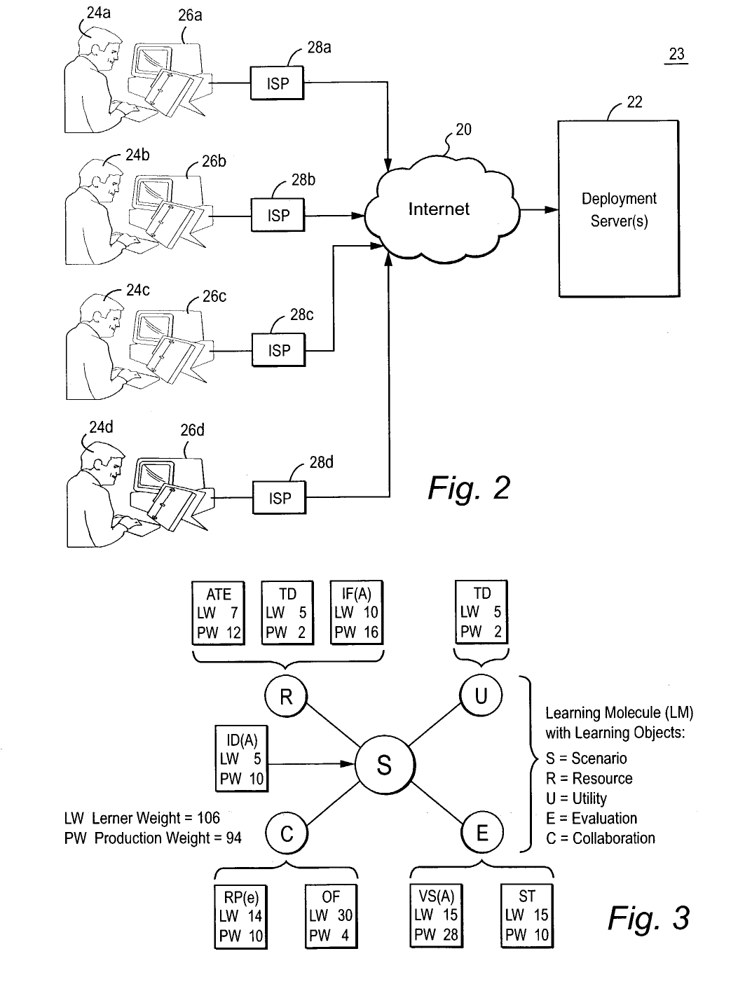

FIG. 2 illustrates plural learners 24a-24d working from associated terminals 26a-26d coupled to the Internet 20, for example, by way of a corresponding Internet Service Provider (ISP) 28a-28d. Using a web browser, each learner accesses the online course at the deployment server 22 after performing an appropriate log-on/authorization procedure.

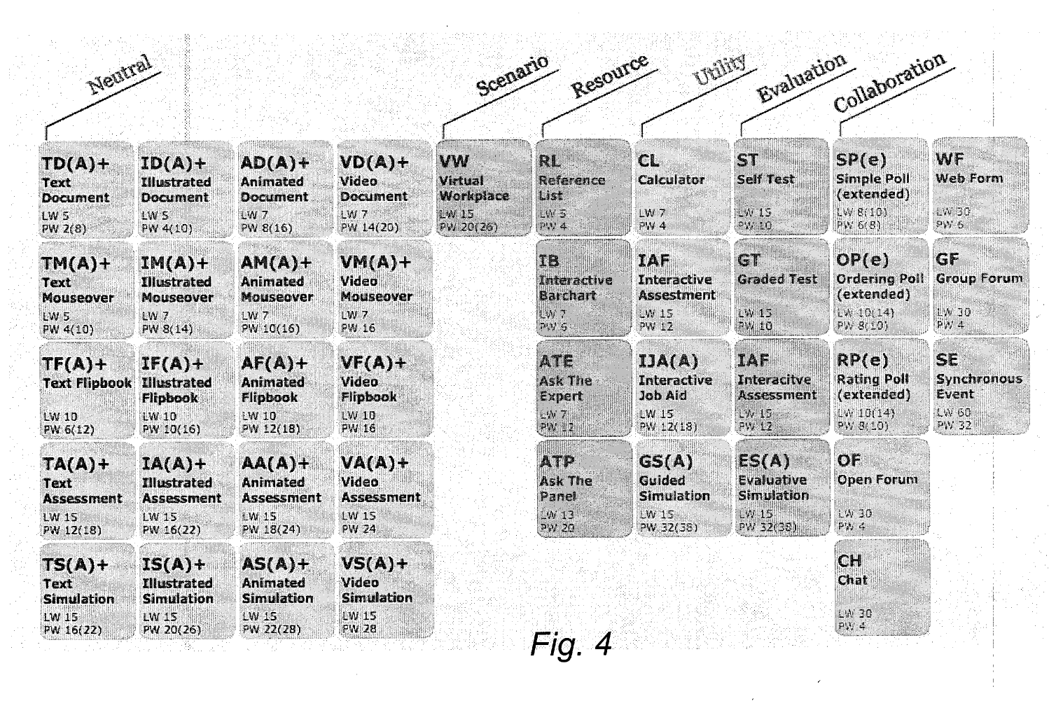

FIG. 3 shows an example learning molecule with the five learning objects. Each learning object is implemented using one or more electronic learning object tools selected from an electronic learning object toolset. Learning object tool types are shown in the learning object tool table, (titled the “Periodic Table of Online Learning Elements”), illustrated in FIG. 4. The learning object tool types include Documents, Mouseovers, Flipbooks, Assessments, and Simulations, each of which can be produced with Text, Illustration, Animation, or Video media (each one with or without Audio).

A learning object tool is essentially a template that can be readily adapted to a particular online course content. Each learning object tool is available for use and reuse every time an online course is being developed. Thus, online course designers need not design new learning object tools from scratch but can simply reuse templates from the learning object toolset, such as that shown in FIG. 4. This also facilitates the standardization of functionality and the particular technologies and programming schemes employed, and in general, allows for consistency across courses.

Each online learning object tool is assigned two numbers analogous to the concept of atomic weight in organic chemistry: a learner weight and a production weight. For example, a text document learning object tool has a learner weight (LW) of 5 and a production weight (PW) of 2. Returning to the example learning molecule in FIG. 3, each learning object tool includes an example learner weight (LW) and production weight (PW). The total learner weight for this example is 106 and the production weight is 94.

Any learning object tool that can be formed by combining a media format Next, Illustration, Animation or Video with or without Audio and/or Advanced Functionality) with an object type Document, Mouseover, Flipbook, Assessment or Simulation) can serve the learning function of Scenario, Resource, Utility, or Evaluation. Additionally, the learning object toolset contains templates for Collaboration learning object tools, as well as other tools that have been (and continue to be) developed to fulfill a specialized learning function as a Scenario, Resource, Utility, or Evaluation. An example of this is the “Ask The Expert” learning object tool, which in essence, is an Illustrated Mouseover with Audio (IM(A)) but that has been developed as a specialized Resource template because of its frequent use.

The individual learning object tools included in the example Periodic Table of Online Learning Elements shown in FIG. 4 are now briefly described. A “neutral” learning function means the learning object tool may be used as a scenario, resource, utility or evaluation. These learning object tools are only examples. More, fewer, and/or different learning object tools may be included.

AA(A), Animated Assessment (with Audio). A graded or non-graded evaluation containing animation (and audio). Learning function: Neutral (Utility or Evaluation).

AD(A), Animated Document (with Audio). A document containing animation (and an audio track). Learning function: Neutral.

AF(A), Animated Flipbook (with Audio). A slideshow with animation (and an audio track). Learning function: Neutral.

AM(A), Animated Mouseover (with Audio). An object containing animation (and audio) with active zones that trigger an event when the user clicks or rolls over them. Learning function: Neutral.

AS(A), Animated Simulation (with Audio). A multiple-path branching narrative containing animation (and an audio track). Learning function: Neutral.

ATE, Ask The Expert. A set of text questions that the student can click and hear a response from an Expert in the field. Learning function: Resource.

ATP, Ask the Panel. Same as an Ask the Expert but with a panel of experts. Learning function: Resource.

CH, Chat. A tool that facilitates svnchronous, text-based communication between two or morel learners. Learning function: Collaboration.

CL, Calculator. A program that lets the learner manipulate numerical data through a graphic interface. Learning function: Utility.

ES (A), Evaluative Simulation (with Audio). A multimedia presentation that evaluates the learner based on the choices made at each step of a branching simulation. Learning function: Evaluation.

GF, Group Forum. Used for group projects, this is the same as an Open Forum but for a subsection of the class. Learning function: Collaboration.

GS(A), Guided Simulation (with Audio). A multimedia presentation that guides the learner to a specific outcome by presenting a variety of narrative paths or choices. Learning function: Utility.

GT, Graded Test. A multiple choice test with feedback provided at the end. Learning function: Evaluation.

IA(A), Illustrated Assessment (with Audio). A graded or non-graded evaluation containing illustrations (and audio). Learning function: Neutral (Utility or Evaluation).

IAF, Interactive Assessment Form. A multiple question form with immediate feedback. Learning function: Evaluation.

IB, Interactive Barchart. Representation of data using a bar chart, where changes in one variable visually affect the other variables. Learning function: Resource.

ID(A), Illustrated Document (with Audio). A document containing illustrations (and an audio track). Learning function: Neutral.

IF(A), Illustrated Flipbook (with Audio). A slideshow with illustrations (and an audio track). Learning function: Neutral.

IJA(A), Interactive Job Aid (with Audio). A multimedia document that facilitates the completion of a task. Learning function: Utility.

IM(A), Illustrated Mouseover (with Audio). An object containing illustrations (and audio) with active zones that trigger an event when the user clicks or rolls over them. Learning function: Neutral.

IS(A), Illustrated Simulation (with Audio). A multiple-path branching narrative containing illustrations (and an audio track). Learning function: Neutral.

OF, Open Forum. An asynchronous group dialogue facilitated via an online discussion board. Learning function: Collaboration.

OP(e), Ordering Poll (extended). A poll with one (or more) questions that asks learners to arrange a number of variables for each question. Learning function: Collaboration.

RL, Reference List. A text document formatted as a list, with collapsible descriptions and/or hyperlink anchors. Learning function: Resource.

RP(e), Rating Poll (extended). A poll with one (or more) questions that ask learners to rate an item along a scale. Learning function: Collaboration.

SE, Synchronous Event. A live interactive presentation delivered through an online broadcasting tool. Learning function: Collaboration.

SP(e), Simple Poll (extended). A poll with one (or more) questions which asks learners to select single items. Learning function: Collaboration.

ST, Self Test. A multiple choice test with immediate correct/incorrect feedback. Learning function: Evaluation.

TA(A), Text Assessment (with Audio). A graded or non-graded evaluation containing text (and audio). Learning function: Neutral (Utility or Evaluation).

TD(A), Text Document (with Audio). A document containing text (and an audio track). Learning function: Neutral.

TF(A), Text Flipbook (with Audio). A slideshow with text (and an audio track). Learning function: Neutral.

TM(A), Text Mouseover (with Audio). An object containing text (and audio) with active zones that trigger an event when the user clicks or rolls over them. Learning function: Neutral.

TS(A), Text Simulation (with Audio). A multiple-path branching narrative containing text (and an audio track). Learning function: Neutral.

VA(A), Video Assessment (with Audio). A graded or non-graded evaluation containing video (and audio). Learning function: Neutral (Utility or Evaluation).

VD(A), Video Document (with Audio). A document containing video (and an audio track). Learning function: Neutral.

VF(A), Video Flipbook (with Audio). A slideshow with video (and an audio track). Learning function: Neutral.

VM(A), Video Mouseover (with Audio). An object containing video (and audio) with active zones that trigger an event when the user clicks or rolls over them. Learning function: Neutral.

VS(A), Video Simulation (with Audio). A multiple-path branching narrative containing video (and an audio track). Learning function: Neutral.

VW, Virtual Workplace. An interactive environment designed to simulate a workplace where clicking on objects triggers various events. Learning function: Scenario.

WF, Web Form. A form containing one or more questions that allows learners to store their answers directly on the form. Learning function: Collaboration.

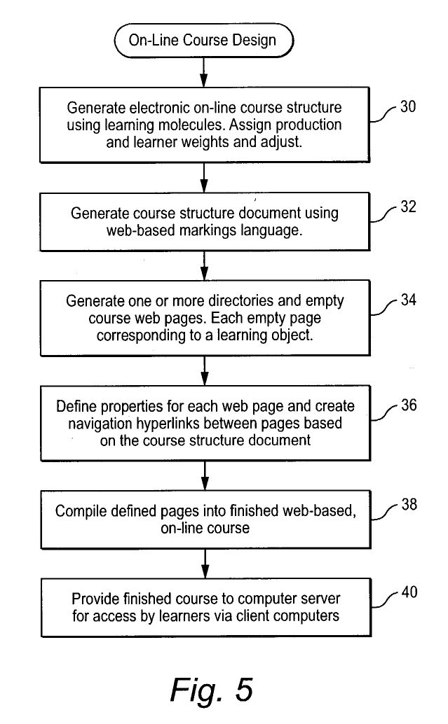

The weights of each learning object tool help estimate the length of the course and the effort needed to produce it before production work begins. For example, assume that a two week course will have a total learner weight of 5 to 7 hours (300-420 points) and a total production weight of 240-400 points. Knowing this before the course is designed helps set expectations and define project parameters. If the initial course design exceeds these limits, subject matter experts and online course designers have a method and vocabulary for negotiating reduction of the weights to appropriate levels. Because the online learning tool set contains tools of various weights that can fulfill the same learning function, the process of reducing the weight of the system does not compromise the quality of the course. For example, if production weight needs to be decreased, a video simulation learning object tool (production weight of 28) can be replaced with an illustrated simulation (production weight of 20) or a text simulation (production weight of 16) while allowing the learning goal to still be met. FIG. 5 illustrates in flowchart form example procedures used to design an online course. An electronic on-line course overview document is generated describing an online course in terms of learning molecules and learning objects. The course overview document describes each learning object needed in the course. It identifies the learning function of each object in the learning molecule, i.e., scenario, resource, utility, collaboration, or evaluation. The course overview also associates each learning object with a learning object tool type (e.g., mouseover, flip book, simulation, etc.) from the learning object toolset. Learner and production weights are determined for each learning object tool, and adjustments may be made for under-weighting or over-weighting.

Using the course overview, a course structure document is then generated using a web-based markup language like XML. An electronic “skeleton” of the online course is created by generating one or more directories for the course with blank web page files that serve as placeholders for course content, each web page file corresponding to a learning object from the course structure document (block 34). The automatically generated web pages in the skeleton course directory are hierarchically organized. A particular set of web pages, corresponding to a learning molecule, forms a course topic, and course topics are grouped together under modules which are assembled to put together a course.

Detailed design guidelines (DDGs) are created for each learning object defining appropriate learning content for that learning object. Each DDG is structured according to the particular learning object tool identified with its learning object. For example, the DDG for an illustrated flipbook learning object has a different formatting than a DDG for a video simulation learning object. After the subject matter expert inserts the course content for this learning object into its corresponding DDG, the DDG document is used to produce the finished learning object.

A course compiler is used to apply properties to each online course web page such as color scheme, course title, and characteristics of a web page bread crumb trail, as well as to automatically generate the navigation hyperlinks between web pages based upon the course stricture document (block 36). The compiler is also used to assign to each learning object in the navigation bar a corresponding display icon (such as a book for Resources, a wrench for Utilities, etc.), title, and/or tag identifier. After review and quality assurance processes, the final web pages (block 38) for the course are provided to a deployment server. The deployment server deploys the online course for access by learners via their client computers (block 40).

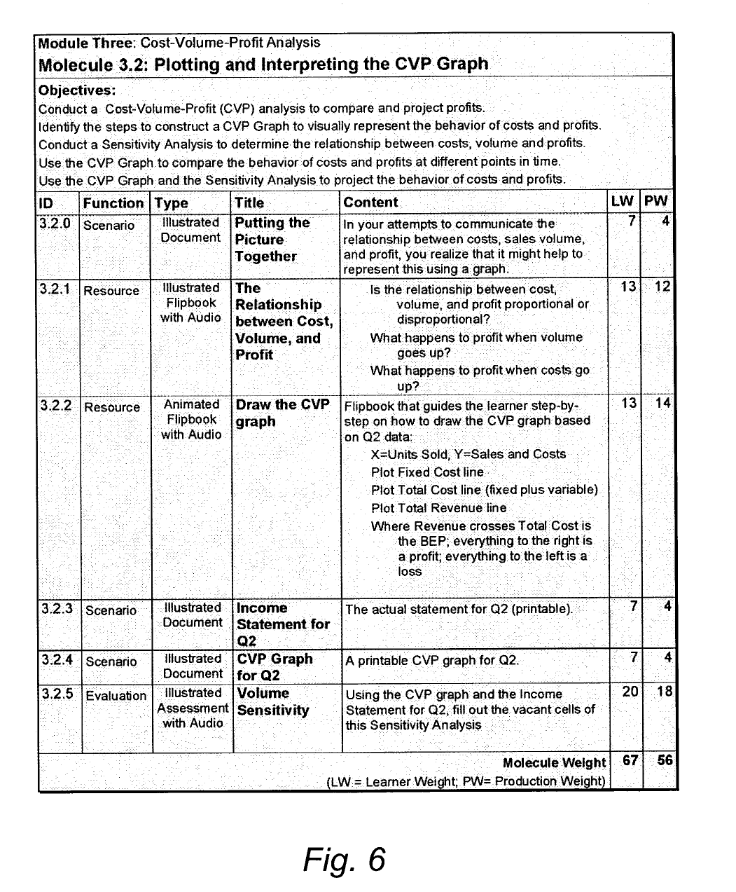

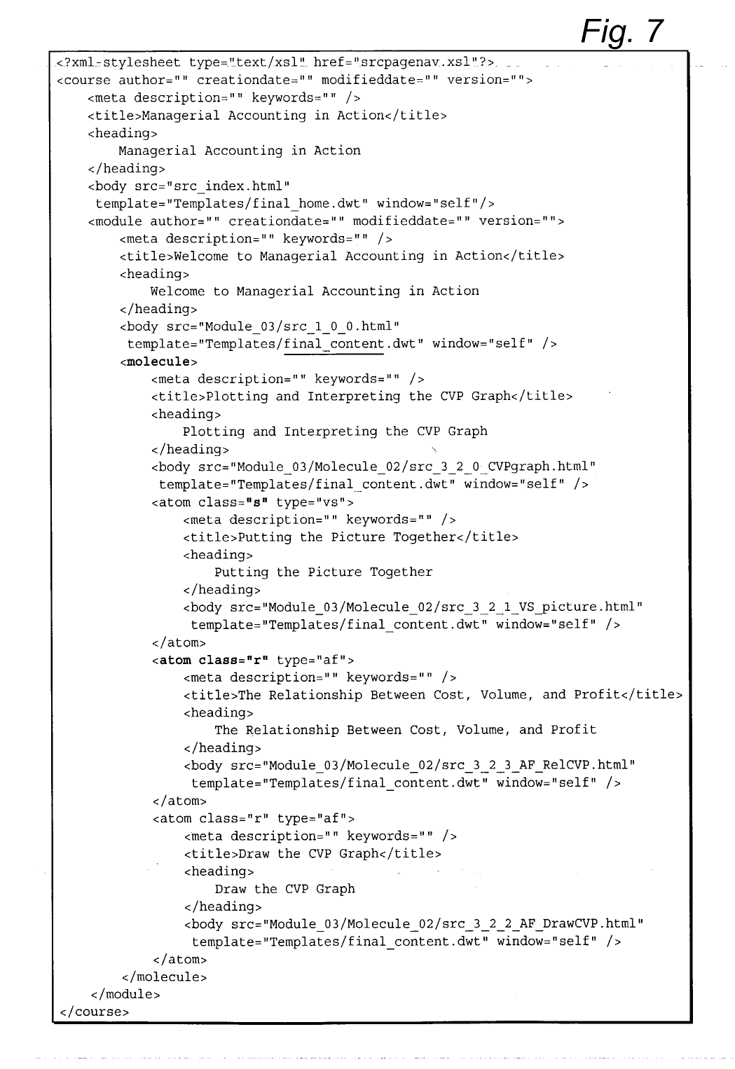

To facilitate understanding, (but not to limit the invention), a simplified illustration of an online course design is now provided. Assume for purposes of this illustration that an online course relating to hotel management is being designed. Further assume that the course overview document has been created by various people on the course design team such as: a learning designer, a subject matter expert, a content architect, and an interactive media programmer. An excerpt of the course overview document is shown in FIG. 6. The illustrated overview document excerpt comes from a course entitled “Managerial Accounting in Action.” The third module in this course is titled “Cost-Volume-Profit Analysis” and includes several learning molecules. One of them is learning molecule 3.2 entitled, “Plotting and Interpreting the CVP Graph.” In addition to listing the objectives for this topic, multiple learning objects associated with learning molecule 3.2 are described. They include three scenario learning objects, two resource learning objects, and one evaluation learning object (identified under the “Function” column in FIG. 6).

Each learning object has a corresponding identifier, e.g., 3.2.0, and a learning object type corresponding to a learning object tool. The learning object types/tools identified include two illustrated documents, an illustrated flipbook with audio, an animated flipbook with audio, and an illustrated assessment with audio. Each learning object has a title, a content description, a learner weight, and a production weight. This “Plotting and Interpreting the CVP Graph” learning molecule has a total learner weight of 67 and a total production weight of 56.

Next, an XML course structure document is generated from the course overview document. An example XML excerpt corresponding to the “Plotting and Interpreting the CVP Graph” learning molecule from FIG. 6 is illustrated in FIG. 7. The XML course structure document models the structure of the course on the hierarchy between modules, learning molecules, and learning objects. The module is identified as module 03/SRC_{—}1_{—}0.html. The learning molecule is identified as “Plotting and Interpreting the CVP Graph.” The learning molecule “atoms” correspond to the learning object and are assigned class (learning function) and type (learning object toolset element) identifiers. A scenario and two resource learning objects are shown in this example. Each learning object has title, body SRC, and template associations. The body SRC tag associates the identified module and molecule with a particular web page. The template tag identifies which page template the compiler must associate with the displayed page. Each of the XML document lines is offset by an open caret “<” and a close caret “>” which corresponds to a “tag.” XML is a desirable format because it allows attributes to be attached to these tags which then can be parsed by the compiler, but the invention is not limited to the use of this programming language.

Once the XML file is created for the online course, a course directory structure with “blank” web page files for each of the modules, learning molecules, and learning object tools is generated. These blank web pages serve as placeholders for the actual content. In this directory structure, each web page file is accessible using a standard HTML editor, allowing course developers easy file access from their workstations during development.

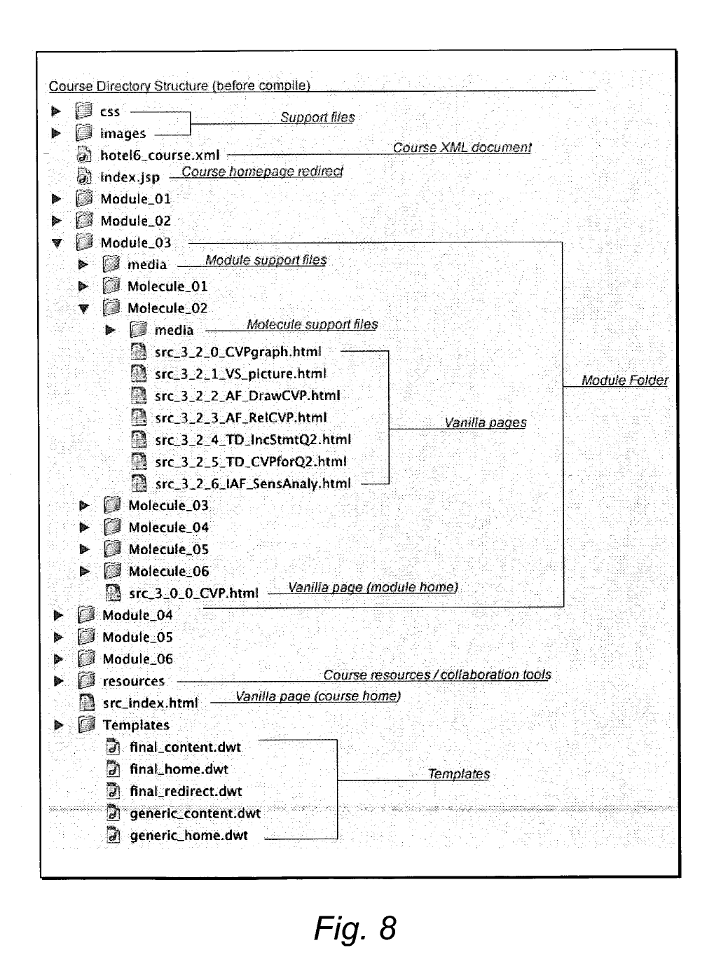

FIG. 8 illustrates an example of a course directory structure before the online course is compiled. The course directory structure includes support files such as style sheets, images, and templates, as well as the various modules, learning molecules, and learning object pages that make up the online course as structured in the XML course document. In this example, there are 6 modules to the hotel management course. Each module has a separate file for each learning molecule. Module 3 has 6 learning molecules. Each learning molecule has an associated media folder where multimedia support files are stored. Represented here are also the blank placeholder web pages, (e.g., src_{—}3_{—}2_{—}0_CVPgraph.html), which correspond to each one of the learning object tools associated with that learning molecule, and which will be filled with the appropriate content from the Detailed Designed Guidelines as they are finished. At the root of the course directory there is also a “css” folder which includes Cascading Style Sheets that establish the global style for the text on each web page in the course. The “images” folder includes graphics that will be loaded into each of the web pages when the compiler is run to output the finished course. The “templates” files include two types. The first corresponds to the “blank” placeholder pages, and the second corresponds to final form templates used by the compiler to generate finished web pages.

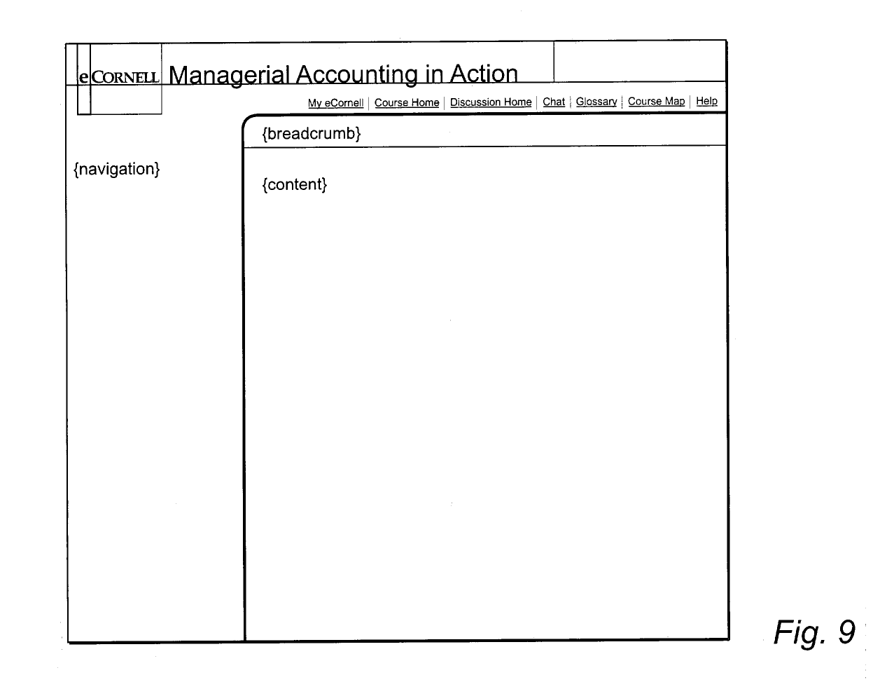

An example of a final form template is shown in FIG. 9. The final form template includes three portions or areas to be filled-in by the compiler: a navigation section on the left, a course content section making up the largest portion of the web page, and a web page breadcrumb and title portion at the top. An example of the course content as it looks once it has been entered into the placeholder page is shown in FIG. 9. “Draw the CVP Graph” is a Resource learning object tool associated with the learning molecule “Plotting and Interpreting the CVP Graph.” The learning object tool in this case is an Animated Flipbook with Audio, (identified in FIG. 6), including various pages with animations that explain how this type of graph is drawn while an audio track plays.

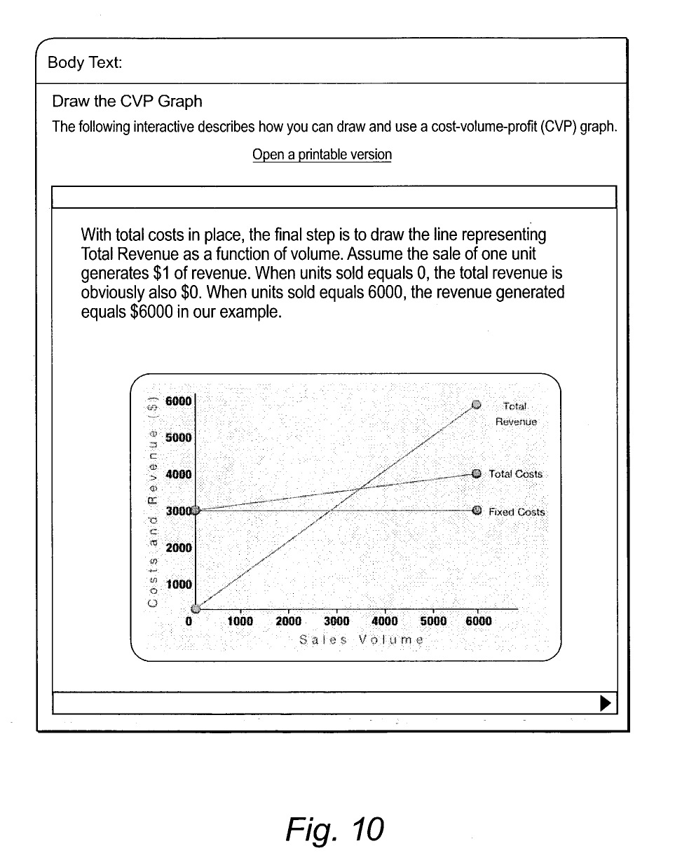

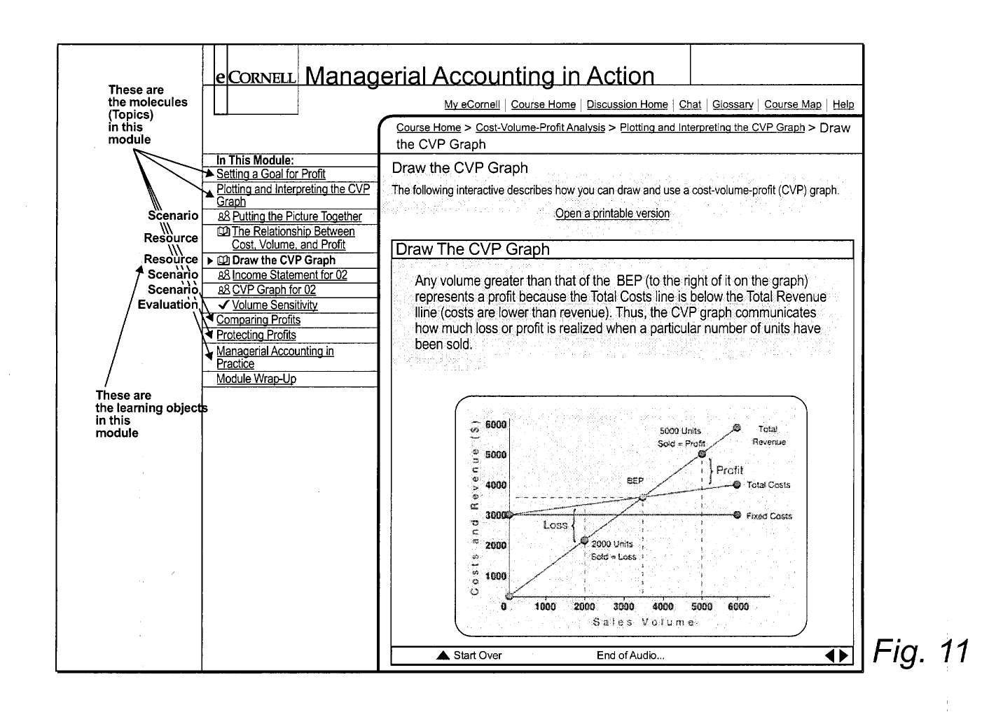

A course compiler applies the final web page template show in FIG. 9 to the learning object tool “blank” page shown in FIG. 10 to obtain a final web page corresponding to the learning object tool. An example of the compiled, finished web page for this example is shown in FIG. 11. The compiler creates navigation hyperlinks that connect this learning object tool to other parts of the course. The course navigation mirrors the module, learning molecule, and learning object tool hierarchy and is illustrated on the left-hand portion of the finished web page. For the current molecule being used as an example, the various associated learning objects are shown as indented hyperlinks. For the currently selected learning molecule, its associated learning objects are highlighted in a different color. Each learning object is also shown with a corresponding learning object icon. A breadcrumb trail is provided above the actual content. The web page breadcrumb trail shows the three most recently visited web pages at the top of the page: Plotting and Interpreting the CVP Graph, Cost-Volume-Profit Analysis, and Course Home.

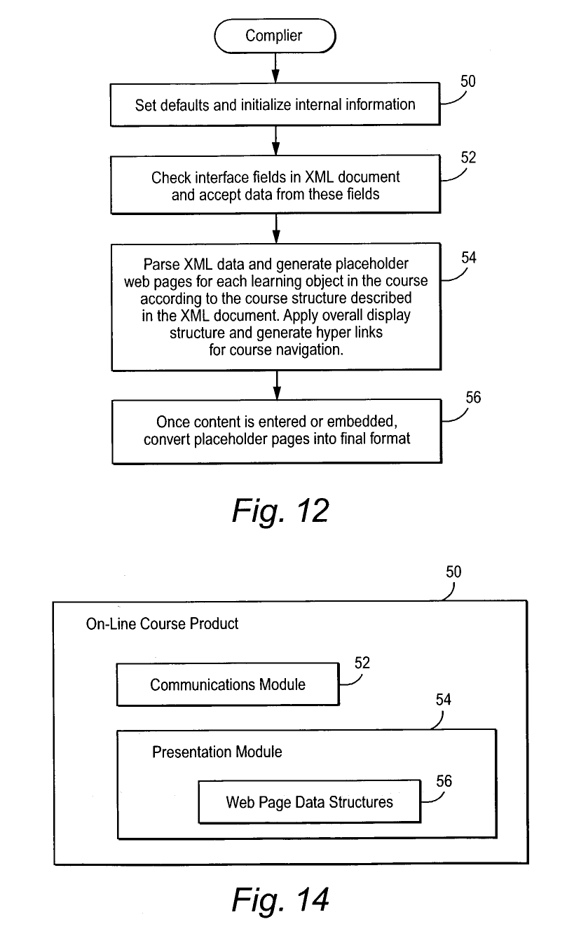

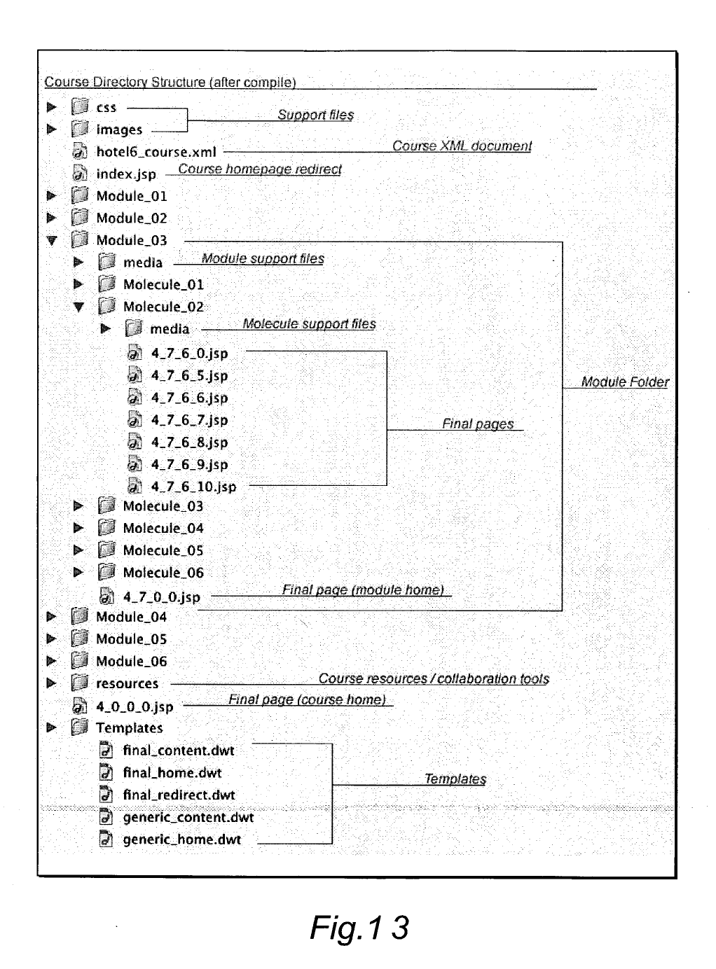

FIG. 12 illustrates example procedures for an online course compiler. Initially, the course compiler sets defaults and initializes internal information (block 50). The compiler receives as input the XML course document, checks the interface fields in the XML document, and accepts data from those fields (block 51). The compiler parses the XML data and generates either blank or finished web pages (depending on the stage of the process) for each learning object in the course. When this operation is performed for the finished web pages, the compiler fills in the overall display structure as well as place holders for breadcrumb navigation and course module navigation (block 52). The finished web page files are then written to the online course directory (block 53). An example of the course directory structure after compiling is illustrated in FIG. 13. The final pages are stored as jsp files. The user runs or opens those pages using a web browser (block 54).

One of the benefits of this implementation is that the course structure can be easily modified by changing the XML document because the XML document mirrors the structure of the course. A change in the online course structure is performed easily by modifying the XML document and recompiling the course. This process is often necessary when it is decided that particular modules, molecules, or learning objects need to be moved within the course. Another advantage is that new course design is greatly facilitated by using different sections of the XML document already created from one or more existing online courses.

The developed online course may be packaged as a memory device product. A simplified example of such an online course product 50 is shown in FIG. 14. This product includes a communications software module 52 and a presentation software module 54. The presentation software module includes the finished web page data structures 56 which were just described. Once this online course product is installed on a deployment server, course learners, coupled to the deployment server via an appropriate network such as the Internet, can easily access the web pages stored in the presentation module 54.

Although the flexible and streamlined development process afforded by the learning molecule model benefit the online course production team, the learner also benefits greatly from its application. The learning molecule model not only provides a consistent usability experience for learners across all courses, but also structures the learning experience in a pedagogically sound manner. By constructing the experience around a real-world scenario, providing access to online resources and utilities, as well as opportunities to evaluate progress and collaborate with other learners, the learning molecule model delivers an effective online learning experience.

While the present invention has been described with respect to particular embodiments, those skilled in the art will recognize that the present invention is not limited to these specific exemplary embodiments. Different formats, embodiments, and adaptations besides those shown and described as well as many variations, modifications, and equivalent arrangements may also be used to implement the invention. Therefore, while the present invention has been described in relation to its preferred embodiments, it is to be understood that this disclosure is only illustrative and exemplary of the present invention. Accordingly, it is intended that the invention be limited only by the scope of the claims appended hereto.

What is claimed is:

1. A computer-aided method for designing an on-line course to be offered on a server computer to client computers capable of communicating with the server computer via the Internet, comprising:
generating an electronic on-line course overview using one or more clusters of learning objects corresponding to learning molecules, each learning molecule defining a course topic around which a learning experience is organized;
generating from the electronic on-line course overview a course structure document describing the course structure using a web-based markup language;
generating from the course structure document one or more directories with placeholder web pages, each placeholder web page corresponding to one of the learning objects associated with each learning molecule;
defining web page properties for each course web page and creating navigation hyperlinks between the course web pages based on the course structure document to generate defined web pages;
compiling the defined web pages into a finished web-based, on-line course; and
providing the finished web-based, on-line course to the computer server for access by the client computers.

2. The computer-aided method for designing an on-line course in claim 1, wherein each learning object includes an associated production weight representing an effort, cost, or time involved in producing that learning object for the on-line course.

3. The computer-aided method for designing an on-line course in claim 2, wherein a production weight for each learning molecule may be determined by summing the production weights of the associated learning objects.

4. The computer-aided method for designing an on-line course in claim 3, wherein a production weight for the on-line course may be determined by summing the production weights of the learning molecules that describe the structure of the on-line course.

5. The computer-aided method for designing an on-line course in claim 1, wherein each learning object includes an associated learner weight representing an average learner's time spent reviewing that learning object in the on-line course.

6. The computer-aided method for designing an on-line course in claim 5, wherein a learner weight for each learning molecule is determined by summing the learner weights of the associated learning objects.

7. The computer-aided method for designing an on-line course in claim 6, wherein a learner weight for the on-line course is determined by summing the learner weights of the learning molecules that describe the structure of the on-line course.

8. The computer-aided method for designing an on-line course in claim 1, wherein the web-based markup language is extensible markup language (XML).

9. The computer-aided method for designing an on-line course in claim 1, wherein each learning object within the learning molecule is described in terms of a learning function, the learning functions representing one of the following: resource, scenario, utility, evaluation, or collaboration.

10. The computer-aided method for designing an on-line course in claim 9, wherein each scenario object provides a context or a motivation for learning.

11. The computer-aided method for designing an on-line course in claim 10, wherein each resource object includes information for understanding the scenario object.

12. The computer-aided method for designing an on-line course in claim 11, wherein each utility object includes information for facilitating application of the resource object information.

13. The computer-aided method for designing an on-line course in claim 12, wherein each collaboration object includes an on-line mechanism allowing plural learners to share, compare, or expand knowledge.

14. The computer-aided method for designing an on-line course in claim 13, wherein each evaluation object includes one or more instruments to measure learner progress or success in the on-line course.

15. The computer-aided method for designing an on-line course in claim 9, wherein each learning object within each learning molecule is implemented with a set of predefined learning object tools.

16. The computer-aided method for designing an on-line course in claim 15, wherein each predefined learning object tool is formed by combining a media format with an object class.

17. The computer-aided method for designing an on-line course in claim 16, wherein the media format includes one of the following: text, illustration, amination, video, each with or without audio, and
wherein the object class includes one of the following: document, mouseover, flipbook, assessment, and simulation.

18. The computer-aided method for designing an on-line course in claim 15, wherein the set of learning object tools includes one or more of the following: an electronic text document, an electronic illustrated document, an electronic animated document, a video document, an electronic text mouse-over, an electronic illustrated mouse-over, an electronic animated mouse-over, a video mouse-over, an electronic text flip-book, an electronic illustrated flip-book, an electronic animated flip-book, a video flip-book, an electronic text assessment, an electronic illustrated assessment, an electronic animated assessment, a video assessment, an electronic text simulation, an electronic illustrated simulation, an electronic animated simulation, and a video simulation, each with or without audio.

19. The computer-aided method for designing an on-line course in claim 1, further comprising:
providing each of the placeholder course web pages with supporting course content.

20. The computer-aided method for designing an on-line course in claim 19, further comprising:
marking a location on each web page where an associated electronic learning object is to be inserted;
producing each of the learning objects described in the on-line course structure according to an assigned learning object tool type; and
embedding each produced learning object into a corresponding course web page at a corresponding marked location.

21. The computer-aided method for designing an on-line course in claim 1, wherein the web page properties include global properties, the global properties including one or more of the following: color scheme, course title, and a web page bread crumb trail.

22. The computer-aided method for designing an on-line course in claim 1, further comprising:
adding an identity property to each learning object,
wherein the identity property is one or more of the following: an icon, a title, and a tag identifier.

23. A system for designing an on-line course to be offered on a deployment server computer to client computers capable of communicating with the deployment server computer via the Internet, comprising:
an on-line course development server;
one or more course design work stations configured to communicate with the on-line course development server;
a course compiler; and
memory, coupled to the on-line course development server, for storing functional learning object tools useable to construct one or more learning molecules, each learning molecule defining a course topic around which a learning experience is organized,
wherein the on-line course development server is accessible by one or more course designers via the one or more course design work stations to assemble a web-based, on-line course using one or more clusters of learning object tools defining one or more learning molecules,
wherein the on-line course development server is configured to establish a web page for each learning object in the defined one or more learning molecules, and
wherein the course compiler is configured to compile the web pages into a finished web-based, on-line course.

24. The system in claim 23, wherein the memory is configured to store an electronic course overview using one or more learning molecules and a course structure document extracted from the electronic course overview, describing an arrangement of the course using a web-based markup language, the on-line course development server further comprising:
means for generating from the course structure document one or more directories and placeholder course web pages that mirror the course structure, each placeholder course web page corresponding to one of the learning objects associated with each learning molecule, and
means for defining web page properties for each course web page and creating navigation hyperlinks between the course web pages based on the course structure document to generate defined web pages.

24. The system in claim 23, wherein the on-line course development server is configured to provide the finished web-based, on-line course to the deployment server for access by the client computers.

25. The system in claim 23, wherein each learning object includes an associated production weight representing an effort, cost, or time involved in producing that learning object for the on-line course.

26. The system in claim 23, wherein each learning object includes an associated learner weight representing a average learner's time spent reviewing that learning object for the on-line course.

27. The system in claim 23, wherein each learning object within the learning molecule is described in terms of a learning function, the learning functions representing one of the following: resource, scenario, utility, evaluation, or collaboration.

28. The system in claim 23, wherein each learning object tool is formed by combining a media format with an object class.

29. The system in claim 28, wherein the media format includes one of the following: text, audio, illustration, animation, and video and the object class includes one of the following: document, mouse-over, flipbook, assessment, or simulation.

30. The system in claim 23, wherein the set of learning object tools includes one or more of the following: an electronic text document, an electronic illustrated document, an electronic animated document, a video document, an electronic text mouse-over, an electronic illustrated mouse-over, an electronic animated mouse-over, a video mouse-over, an electronic text flip-book, an electronic illustrated flip-book, an electronic animated flip-book, a video flip-book, an electronic text assessment, an electronic illustrated assessment, an electronic animated assessment, a video assessment, an electronic text simulation, an electronic illustrated simulation, an electronic animated simulation, and a video simulation, each with or without audio.

31. A software product including memory storing a web-based, online course, comprising:
a communications software module for communicating with one or more client computers associated with persons taking the web-based, online course, and
a presentation software module for storing course web page files, at least one of the web page files including:
a first data structure including a course module comprising learning molecules, each learning molecule defining a course topic around which a learning experience is organized and including one or more learning objects, wherein each learning molecule has an associated hyperlink and each learning object has an associated hyperlink, and
a second data structure including display information corresponding to a selected learning molecule or learning object.

32. The software product in claim 31, wherein the one web page file includes a third data structure for identifying the on-line course when the one web page is displayed.

33. The software product in claim 31, wherein the one web page file includes a fourth data structure corresponding to a web page, hyperlink breadcrumb trail.

34. The software product in claim 31, wherein the presentation module is configured to present for display for the one web page the course module learning molecules as hyperlinks.

35. The software product in claim 34, wherein when one of the learning molecule hyperlinks is selected, the presentation module is configured to present for display each of the selected molecule's learning objects as a hyperlink.

36. The software product in claim 35, wherein the presentation module is configured to present for display an icon associated with the displayed learning objects that represents the learning function of each learning object.

37. The software product in claim 34, wherein the presentation module is configured to present for display the learning molecule and learning object hyperlinks in a first display screen area, course content corresponding to a selected hyperlink in a second display screen area, and navigational guidance in a third display screen area.

38. The software product in claim 31, wherein the learning objects are associated with one the following: an electronic text document, an electronic illustrated document, an electronic animated document, a video document, an electronic text mouse-over, an electronic illustrated mouse-over, an electronic animated mouse-over, a video mouse-over, an electronic text flip-book, an electronic illustrated flip-book, an electronic animated flip-book, a video flip-book, an electronic text assessment, an electronic illustrated assessment, an electronic animated assessment, a video assessment, an electronic text simulation, an electronic illustrated simulation, an electronic animated simulation, and a video simulation, each with or without audio.
